(19) United States
(12) Patent Application Publication
(10) Pub. No.: US 2026/0361671 A1
(43) Pub. Date: Nov. 12, 2026

(54) SYSTEM AND METHOD FOR RESPONSIVE EMOTIVE MESSAGING

(71) Applicant: T-Mobile USA, Inc., Bellevue, WA (US)

(72) Inventor: Cameron Byrne, Seattle, WA (US)

(21) Appl. No.: 19/201,786

(22) Filed: May 7, 2025

(51) Int. Cl. H04L 51/04; H04L 51/08; H04L 51/10

(52) U.S. Cl. CPC H04L 51/04; H04L 51/08; H04L 51/10

(57) ABSTRACT

A message server receives data of an edit action by a first user device to a portion of the content of a first message that is sent by a second user device. The edit action includes at least one of content selection of the portion of the content or associating a graphical icon with the portion of the content selection within the first message. The message server generates a second message configured with at least one of a representation of the content selection to the portion of the content within the first message or an association of the graphical icon by the edit action to the portion of the content within the first message. The message server sends the second message to the second user device for display at the second user device.

### BACKGROUND

It has become common for users of mobile devices to send messages over wireless networks to other mobile devices. Such messages include messages sent as Short Message Service (SMS)/Text messages, Multimedia Messaging Service (MMS), and Instant Messaging such as iMessage®, TELEGRAM®, and WHATSAPP®. Some types of messages, such as Multimedia Messaging Service (MMS) messages, also allow other types of media to be sent instead of or in addition to text, such as images, audio, and video.

In wireless messaging, recipients often acknowledge a sender's message through a practice known as “emoting.” Emoting involves expressing emotions in response to a message using emotion-based symbols such as emojis, emoticons, animated GIFs, or stickers. This form of communication enables recipients to quickly convey their emotional reaction without composing a complete response, thus saving time while still providing an immediate and expressive acknowledgment. Emoting enhances message interactions by visually representing emotions like surprise, happiness, or excitement. In many cases, extended message exchanges include a wide variety of emoticons exchanged between participants.

Messaging standards have advanced to provide additional features beyond simply sending messages. For example, GSMA's Rich Communication Services (RCS) standard can allow devices to be informed when sent messages have been received, as well as when users are sending a reply to messages on other devices. RCS also supports other advanced features, including group chat, file transfers, and content sharing.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example network environment in which a user device (recipient) accessing a network can respond to a message sent by a user device and select parts of the message to emote according to some examples.

FIG. 2 depicts a series of exemplary messages displayed on displays between users. According to some examples, portions of the text in the responsive messages are highlighted and associated with an emoticon in response to the user's message.

FIG. 3 depicts a set of edits to messages on a display of a recipient user device where a user selects multiple parts of a message and associates a graphical icon with one or more parts, according to some examples.

FIG. 4 depicts a diagram of an image in a message that is received by a user device and edits actions within the image according to some examples.

FIGS. 5A and 5B illustrate sequence diagrams of operations that can be used to emote response messages in which text portions have been selected and associated with emoticons or other graphical icons by at least the user, according to some examples.

FIG. 6 illustrates a computer system suitable for implementing one or more examples disclosed herein.

### DETAILED DESCRIPTION

### Introduction

Wireless networks are often used to send messages between communication devices. Such messages include text messages. Such messages can also include multimedia messages that include images, video, audio, and/or other types of media instead of, or in addition to, text. Users express their emotions or reactions in what is known as emoting in messages. Emojis or Emoticons are symbols or icons that are expressions of emotions that help to add personality or emotional context in text-based or image-based communications.

When using wireless messaging, recipients often acknowledge a sender's message by employing a technique commonly known as “Emoting.” Generally, emoting in messages is a manner in which people express emotions when responsively communicating in messages to acknowledge the sender's message and to provide an emotion-based symbol as a response. Emoting and using emojis or emoticons in the response allows the recipient to spend less time formulating a response and provide an excited type of utterance to a response, immediately saving time and yet still capturing the recipient's feelings about the message and conveying those feelings with immediacy to the sender. Emoting is often digital icons or text-based symbols that visually convey various emotions such as surprise, happiness, or other feelings. Also, emoting can include animated GIFs or stickers to express emotions in message communications. In a series of message exchanges, dialogue of responses may include a plethora of different emoticons sent by recipients in the message exchanges that allow for quick, rapid-fire communicative responses. By using emoticons that visually represent emotions as mentioned of surprise, happiness, or excitement, emoting enriches the overall communicative experience between parties by inserting or conveying emotions into a written or image context in the communication flow. In many instances, extended message threads feature a diverse array of emotive symbols exchanged between participants.

In some examples, emoting or reactions to express an emotional response to a message is performed by tapping and holding onto a message and selecting an emoji reaction. For example, for iMESSAGE®, a user can react to a message by tapping and holding on to the message and then choosing an emoji reaction from the options that appear. For an ANDROID® device, a user can react to a message by tapping and holding on to the message, similarly and selecting an emoji reaction. Doing so and using the emoji can, among other things, quickly and easily convey feelings like agreement, disagreement, amusement, or surprise. For example, the user can reinforce the meaning of the message as the Emoticons, when used in conjunction with a written message, can help to increase the “intensity” of its intended meaning, or the user can Reduce ambiguity in the message with Symbols with a universally understood meaning can help to convey a sentiment without having to phrase it in a convoluted sentence.

In some examples, the present disclosure describes methods and systems that enable selectively inserting an emoticon into a textual passage by highlighting a portion of the text passage and inserting the emoticon in the interior of the textual passage in a manner that is associated with the highlighted text. For example, a user may highlight, when receiving a message, a set of words in the text obtained from the message by manual selection and then insert an emoticon adjacent to the highlighted text in a manner that makes it readily apparent that the emoticon is meant to convey an emotion to the highlighted text.

In some examples, this process of highlighting text in a message and attaching it adjacently to the highlighted text not only makes the text stand out but also is a quick way to be responsive to the text, to show the sender that the recipient has read the text, and to convey some emotion to an interior part of the message received in an immediate response to the sender. Also, other ways of selecting text, other than highlighting the text, may include using unique styling and changing the size of the chosen text.

In some examples, the present disclosure provides systems and methods to receive messages (or images) using a recipient communication device coupled to a message server, where a message, such as a text message, is being received from a sender device. In response to receiving the message by the recipient device, the message is displayed on the recipient device and configured with an interface control or other interface control to receive selective input to edit or make insertions within the context of the message that is received. In an example, the message server is configured to display the message on a display associated with the recipient device with an interface control to receive edits or inputs within the interior part of the message based upon a triggering action to the message by the user. The user of the recipient may selectively touch the message with a selective touch operation of holding down the text in the message to trigger the interface control and initiate an interface control edit process for selectively editing the message.

In some examples, the interface control edit configuration may be initially actuated with a template of the interface control that is configured for the entire message after a pressing and holding action of the message for a first period of time and after the continued pressing and holding of the message providing for a second template of the interface control that allows for edit actions of selecting of text within the message and assigning graphical icons such as emoticons to the selected text. In another example, a single template of the interface control is configured that allows for editing of the interior or within the message and selecting of text to associate with emoticons.

In some examples, in either mode that allows for editing within the message using the template of the interface control, the user can tacitly or by touch select on the display of the recipient device select portions of text inside of a textual message where the touch or tactile operation defines the amount of textual area and text that is selected. The interface control, therefore, allows by being configured for a single mode or dual mode by the manual actuation and pressing of the message displayed on the display for one or more periods of time to select all or selected portions of text to be each associated with an emoticon or other graphical icon inserted within the message.

In some examples, the message server may reformat the message to better present the text selections with the emoticons or graphical icons that have been selected and inserted into the textual context. For example, after an initial text selection, the font or color of another text selection may be automatically changed, or maybe to a color that is coordinated or associated with a graphical icon that is selected to be associated with the text. The message server may also employ machine learning algorithms to edit and automatically refine the text selections and the graphical icons that have been inserted within the message to better express the emotions that the user wants to convey. For example, Natural Language Processing (NLP) algorithms and/or other content-based generative AI or transformer based machine learning (e.g., transformer based-Large Language Models (LLMs)) may be employed within the interface control configuration to be used when a user is selecting text portions and graphical icons to understand the user selections and to provide tools and suggestions to the user to make better the user selections within the message.

In some examples, the message, combined with the interface control edits that have been generated inline, is sent upon receiving user input or action to the original sender device. In this instance, the edits composed in the interface control are now integrated into the returned message that is being displayed. The message on both the recipient device and the sender device is or may be generated as an inline annotated message. That is, the message remains in a static display mode of the original message, but for the additional insertions, with the context of the message. Similar to how emoting is employed with a message, a new message string is not generated; instead, the same or similar message string or inline message is used with a modified message that includes the overlaid edits within the interior of the message.

Described herein are systems and methods for implementing a messaging application that enhances memory optimization by minimizing data transfer using single-byte or multi-byte Unicode code points as an emoji acknowledgment (ACK). This configuration informs a message server of a network when an emoticon or other graphical icon becomes associated with a selected portion (e.g., highlighted text inside a message) of text or a selected part of an image within a message, which is sent from one communication device to be distributed to others responding to the message. In some examples, data transfers using a single Unicode point can represent standardized acknowledgment emojis, where the code point explicitly confirms message reception with data that omits any bitmap or vector representation of the emoji, which can reduce data transfer compared to image-based acknowledgments. The techniques, apparatus, and/or systems described herein may be implemented in various ways.

Example implementations are provided below with reference to the following figures.

### Example Environments

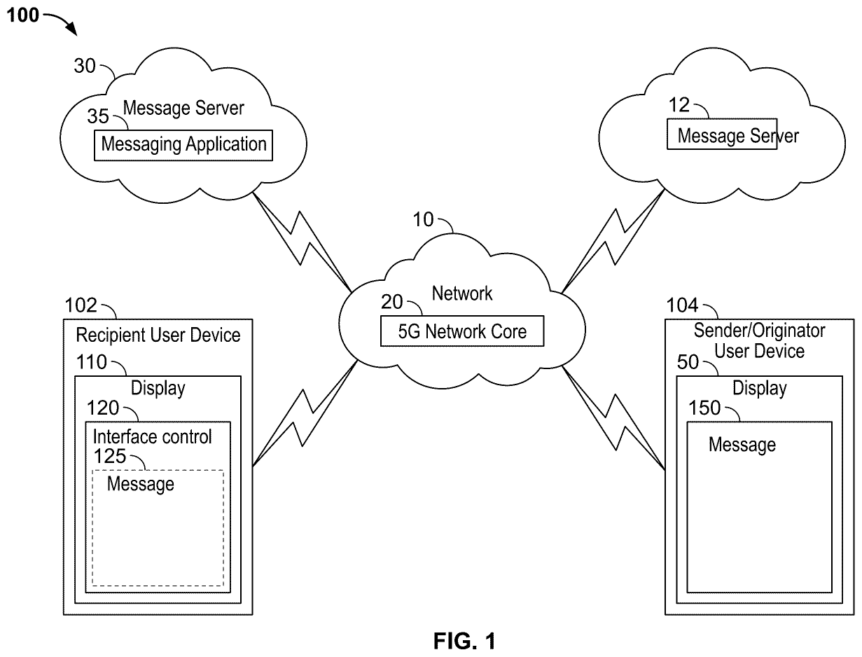

FIG. 1 illustrates an example network environment 100 in which a user device 102 (recipient) accessing a network can respond to a message 150 sent by a user device 104 and select parts of the message to emote with in accordance with some examples. In FIG. 1, the example network environment 100 illustrates a set of user devices 102 and 104 that are configured to communicate with each other using network 10 and message application 35 hosted on a message server 30.

In some examples, the user device 104 acts like a sender device that displays on display 50 a message to be sent to the user device 102 and represented as a message 120 on display 110. When the user of device 102 manually presses on the message 120, holding down the message for a period of time, the messaging application 35 is triggered to generate an interface control 125 that covers the message. The triggering of the interface control 125 enables the user to select the text of the message 120, and once selected, the messaging application 35 highlights the selected text. It generates a series of emoticons to be inserted in the message 120 (an inline text insertion) to be associated with the highlighted or selected text.

The message 120 is then, after another action, such as the selection of the emoticon is shown by the message application 35 on the display 50, the message 150 with the emoticon inserted into the message 150 with the highlighted portion selected by the user of the recipient user device 102. In this manner, a portion or segment within the message 150 is highlighted and associated with the emoticon rather than the entire message being associated in an exterior placement of the emoticon to the message 150. The sender's user device 104, on its display 50, sees a representation of the message 150 with an emoticon in at least its interior. The user selects highlighted text with the message 150, and the originator of the message 150 can identify the portion of the message 150 that the recipient who has received the message 150 is focused on within the message 150.

In some examples, the interface control 125 is generated by the messaging application 35 with a number of modes and features. In an example, a single interface control is generated upon the user pressing and holding down the message 120 on the user's device. In another example, multiple interface controls are generated by the messaging application 35 upon triggering by the user on the display 110 of the user device 102. For example, using artificial intelligence and/or machine learning algorithms, the message 120 is automatically segmented into multiple textual portions or text segments that the user can select. For example, the user of the recipient device 102 may select one or more text segments and attach an emoticon. The user may also attach different emoticons to one or more text segments that have been interface-controlled by the messaging application 35.

In some examples, the interface control 125 may be configured in one or more modes based on the length of time that the user presses and holds down the message. For example, a first period of time or the shortest period of time of pressing on the message and holding down the message on display may result in an interface control 125 that is generated by the messaging application 35 that is configured to cover the entire message 120. In a second period of time or a longer period of time, pressing on the message and holding down the message on the display may result in an interface control 125 that is generated by the messaging application 35 to segment the message to enable the user to pick and select a segment to be associated with an emoticon. In a third period of time or an even more extended period of pressing on the message and holding down the message on the display may result in an interface control 125 that is generated by the messaging application 35 with segments of the message automatically highlighted using artificial intelligent algorithms that ingest the content the of the text of the message and may also be configured to suggest or insert emoticons within the message. Hence, the period of time for pressing onto the message in the display of the user device may trigger one or more interface control operations that enable different modes of insertions of emoticons or other graphical icons and can also be automatically configured using intelligent algorithms to save time and enable faster responsive notifications to the sender devices.

In some examples, both the recipient user device 102 and the sender's user device 104 may be connected in a variety of different chat communication sessions using different messaging applications such as WHATSAPP®, GOOGLE CHAT®, RCS messaging platforms, and SMS messaging platforms using at least one compatible message server 12 that allows one or more users to participate in communication sessions between at least one other user device that may include such communications multimedia messaging, text messaging, data transfers, or other communication types. For example, a message server 12 may be a rich communication services (RCS) server. In some examples, the example network environment 100 may employ a host of different systems for communications that include cellular-based systems such as a 4G, 5G, or 6G system, a Wi-Fi system, or Bluetooth connectable devices. In some examples, the recipient's user device 102 may connect with a 4G/5G/6G system (or other cellular system) to exchange a series of communications in a chat session between one or more other user devices (e.g., user device 104) that are connected to the example network environment 100. In one instance, the user device 102 may send a response of an emoticon within a message communication (e.g., a group chat) to one or more additional user devices 104.

In some examples, an exemplary 5G system of network 10 (or other 4G/6G system) may include a core network 20 and a message server 12, which is configured to provide real-time communication services between the recipient user device 102 and the sender user device 104. In some implementations, the sender user device 104 can generate a message containing a request to confirm a meeting, initiate a group chat, or confirm an event to the recipient user device 102. The recipient's user device 102, in response, can provide a confirmation with an emoticon, highlight the request, and insert other links as selectively determined or automatically provided using intelligent solutions of the messaging application 35.

In general, the recipient's user device 102 and sender's user device 104 receive communications from the message server 12 in accordance with RCS, SMS, or MMS protocols via the core network 20. For example, the message server 12 might receive data from user device 102 or user device 104 requesting a group chat and then format messages between the two as part of that chat. This data may include a group identifier (or multiple identifiers) specifying which user devices should be part of the conversation. In various scenarios, the message server 12 determines the first operating system associated with user device 102 and the second operating system associated with user device 104 based on these identifiers, then prepares the group chat so that both operating systems (e.g., ANDROID® and a different OS) can recognize it.

In particular examples, the message server 12 using intelligent algorithms of the messaging application 35 can initiate, establish, maintain, format, augment, manage, or otherwise facilitate secure text, video, and photo exchanges in a group chat according to one or more user devices' preferences (e.g., preferences of user device 102 or user device 104). As noted, the message server 12 can detect each user device's operating system type (e.g., iPhone, Android, etc.) and arrange a group chat compatible with each OS, even if different devices use different platforms, often referred to as an “open group chat.” In some instances, the message server 12 can configure an open group chat containing RCS messages, SMS messages, MMS messages, iMessages, or any suitable combination. User preferences, possibly collected through a user interface, may specify which devices receive full or partial content (e.g., text only, without video or photos) or when to switch from one device to another based on timing or location.

The user device 102 and user device 104 may be any device capable of wireless communication, such as a smartphone, tablet, media player, gaming console, smartwatch, hotspot, or any other computing or communication device.

In some deployments, the core network 20 of the example network environment 100 provides the functionality needed for communication between user device 102 and user device 104. It may include one or more radio access networks (RANs) as well as one or more core networks that connect to these RANs. For example, user device 102 might connect wirelessly to a base station in a RAN, which in turn links to the core network 20. The RANs and/or core networks can support various radio and wireless access technologies, including fifth generation (5G), Long Term Evolution (LTE)/LTE Advanced, other fourth generation (4G) systems, High-Speed Data Packet Access (HSDPA)/Evolved High-Speed Packet Access (HSPA+), Universal Mobile Telecommunications System (UMTS), Global System for Mobile Communications (GSM), Wi-Fi, or any current or future technology. In this manner, the core network 20 can interoperate with other radio technologies from various providers, allowing a message in the group chat originating from user device 104 to user device 102 under a different provider's network to be processed by the message server 12 regardless of the underlying technologies or networks in use.

In some instances, the core network 20 is a service-based architecture consisting of different network functions that handle control plane and/or user plane data to deliver services to user device 102. These services may include rich communication services such as text exchange, data file transfers, image sharing, video messaging, or any combination of these. The network functions can include an Access and Mobility Management Function (AMF), a Session Management Function (SMF), a User Plane Function (UPF), a Policy Control Function (PCF), or any other relevant function implemented in software and/or hardware. FIG. 1 depicts a messaging environment in which communication devices (e.g., user device 102 and user device 104) can receive (and send) messages through a network 10.

Additionally, “user device,” as used herein, is a device that has the capability of using a wireless telecommunications network and may also be referred to as a “computing device,” “mobile device,” or “user equipment” (UE), or “wireless communication device.” A user device, in some aspects, may take on a variety of forms, such as a PC, a laptop computer, a tablet, a mobile phone, a PDA, a server, an Internet of Things device, or any other device capable of communicating with other devices (e.g., by transmitting or receiving a signal) using a wireless communication, or one or more combinations thereof. A user device may be, in an embodiment, similar to the communication device 102 described herein with respect to FIG. 1.

A user device 102 is a communication device that can wirelessly connect to the telecommunication network 10 and engage in sending and/or receiving messages. For example, a user device can be a smartphone, a cellular phone, a personal digital assistant (PDA), a personal computer (PC), a laptop, a desktop, a workstation, a media player, a tablet, a gaming device, a smartwatch, or any other type of computing or communication device. A user device 102 can also be referred to as user equipment (UE), a mobile device, or a mobile station (MS).

Elements of the telecommunication network 10 can be based on one or more wireless access technologies and/or provide communications and network access to user devices 102 through one or more wireless access technologies. For example, wireless access technologies can include fifth generation (5G) technology, Long Term Evolution (LTE)/LTE Advanced technology, High-Speed Data Packet Access (HSDPA)/Evolved High-Speed Packet Access (HSPA+) technology, Universal Mobile Telecommunications System (UMTS) technology, Code Division Multiple Access (CDMA) technology, Global System for Mobile Communications (GSM) technology, WiMax® technology, and WiFi® technology.

A message from the user device 102 can be a message sent in response (or from) from an originating user device 104 to one or more terminating user devices (e.g., user device 104) with a highlighted portion and inserted in the message, a graphical icon such as an emoticon. A message can include text and/or other media. In some examples, a message 120 can be a Short Message Service (SMS) text message. In other examples, message 120 can be a Multimedia Messaging Service (MMS) message that can include text and/or other types of media, such as images, descriptive information with audio files, and video files that can be edited and highlighted by user selection or automatically with graphical icons such as emoticon to emote responses to the file sent. In still other examples, message 120 can be a Rich Communication Services (RCS) message.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example, and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

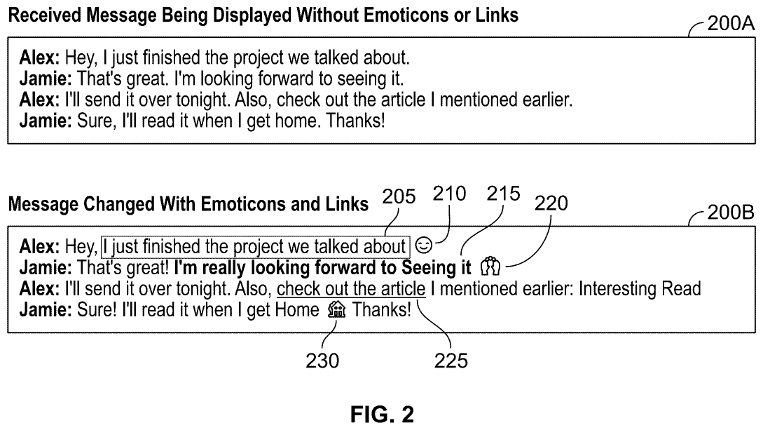

FIG. 2 depicts a series of exemplary messages that are displayed on displays between users, with portions of the text in the responsive messages being highlighted and associated with an emoticon in response to the user's message, according to some examples. In FIG. 2, in diagram 200A, a set of messages are sent between users without any portions within the messages selected by the responding user to be highlighted and responded to. In diagram 200B, the message includes a portion highlighted 205 and an emoticon 210 inserted at the end of the message. In an instance, the user, in this case the responsive user, would press and hold on to the entire message.

The interface control (interface control 125 of FIG. 1) feature in a chat session would be executed by the messaging application 35 (of FIG. 1) to enable a user to select a portion of the message to highlight, and then upon the highlighting of the portion of the text in the message, automatically generate a set of emoticons that the user would select for insertion within the text of the message. In this instance, the emoticon 210 is inserted at the end of the highlighted portion. In message 215, the text portion is selected but highlighted using a different format to bold the text within the message. Upon completing the edit operation to select text to be bolded, another emoticon, 220, which may be automatically generated (or selected), is inserted by the messaging application 35 at the end of the bolded text portion. In some examples, the editing operation or process may involve adding, deleting, moving, inserting, resizing, formatting, changing colors, and repositioning text, characters, and other elements within a message. In some examples, the data received from the edit operation through the interface control configured over the content displayed on the user's screen by the message server allows the user to attach a graphical icon to the interior portion of the content. In an example scenario involving a chat app such as “SwiftChat” that supports in-line reactions, the originator may send a message: “Just signed the agreement—our product launches next month!” An interface control interaction is configured where the user taps and holds the phrase “our product launches next month!” A translucent interface control appears above that text segment, offering quick-reaction icons (e.g., emoticons), and the user taps a happy face emoticon.

In message 225, a portion of the text is selected by the user in the response, and the recipient inserts a hyperlinked response as the article referred to, check out that the responding user believes it is to be checked out. Also, a different graphical icon 230 that is associated with the context of the message may be automatically inserted as a response by user selection of the text, in this case, the text “home”.

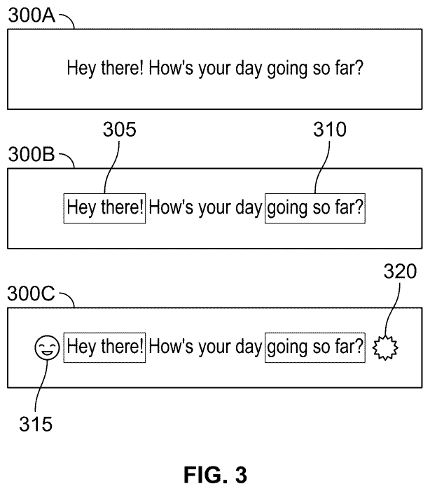

FIG. 3 depicts a set of edits to messages on a display of a recipient user device where a user selects multiple parts of a message and associates a graphical icon with one or more parts, according to some examples. In FIG. 3, in the exemplary message 300A, a user receives a message from a sender user device that is simply text without any emoticons. In other words, a commonly sent first message in a chat session. In response, the recipient may first select the message (in its entirety) by touching and holding down the message on a touch-sensitive screen for a particular time period.

For example, the messaging application 35 (of FIG. 1) can be configured to generate an interface control 125 (of FIG. 1) that allows for editing actions within a single time period. In this first example, the entire text would be available for the user to select text within the message after touching and holding down the message for a single predetermined time period. In a second example, the user would have to hold the message for a more extended period (a second period of time) to allow for editing of text within the message. In this example, a first type of interface control would be generated by the messaging application that allows for adding of the emoticon on the exterior after the first time period, and then only after touching and holding down the message for a more extended period that is longer than the first time period or for a second time period would be generated that allows for editing of the interior text of the message. That is, after the second time period, a second type of interface control that is different from the first type of interface control would be automatically configured by the messaging application to allow for editing within the message.

In FIG. 3, with respect to 300B, when the interface control is configured by the messaging application to allow for editing actions within a message, the user may select the first part of the text 305 of the exemplary message 300B using a touch selection on a touch screen as an example on the user's user device. Once the text has been selected within the message, the message application will automatically present one or more graphical icons to be selected by the user to be associated with the first part of the text.

Next, during the same editing session, the user may select a second part of the text 310, and the messaging application 35 (of FIG. 1) would again present a set of graphical icons for selection. Once the user has finished making selections within the message and selections of graphical icons, the user may perform an action such as a return operation or touch operation outside the messaging area or some other operation that triggers the messaging application that the edit actions to the text are complete. Once completed, the messaging application represents the message 300C, as shown in FIG. 3 with the graphical icon 315 associated with the first part of the text that has been selected, and the graphical icon 320 associated with the second part of the text that has been selected, and this representation is displayed inline in the message on both the recipient device and the sender device. Hence, both the recipient and the sender are aware of the response that has been provided. For example, the graphical icon may be selected as an emoticon, and the emoticon selected would automatically be associated with text within the message that has been received. The response of the text selection and emoticon presented would allow the recipient to respond quickly to a particular portion of the text within the message in a fast and immediate manner without having to retype the message or the portion of the text within the message that the recipient wants to accentuate or highlight with an emoticon or the like, or just wanting to accentuate or highlight in itself.

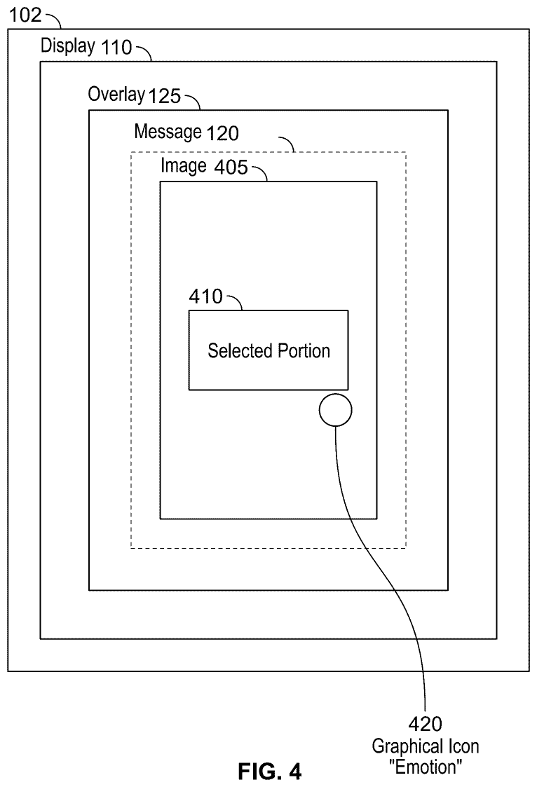

FIG. 4 depicts a diagram of an image in a message that is received by a user device and edits actions within the image according to some examples. In FIG. 4, the user device 102 in its display 110 receives and displays a message 120 that contains an image 405. Similar to editing a message, the user presses and holds the message, and an interface control 125 is generated by the messaging application that allows the user to make selections within the image. For example, the user may, using touch operations, select an area within the image. The image may be automatically segmented into different regions or parts of the image using template-matching algorithms or other image processing techniques.

Once the user has identified an area within image 405 or a portion of the image selected (selected portion 410), the messaging application is triggered to display a set of graphical icons 420 that the user can select from and would are associated with the portion that has been selected. In some examples, multiple portions of the image may be selected, and multiple graphical icons can be generated by the messaging application associated with each selected portion of the image. In some examples, once the selection portion and icons have been identified within the image, the user may perform a completion action, such as a return or other triggering operation, that notifies the messaging application that all the edits have been completed. The message 120 (of FIG. 1, as an example) with the image and modifications of the selections with graphical icons is then displayed on both the sender's device and the recipient's device, with the changes that the user has selected. While the techniques above are described in the context of an interface control in the form of an interface control (e.g., the interface control 125) over content, the interface control may be substituted with other interface controls that are functionally similar in other embodiments. For example, other interface controls may include an outline that encloses relevant content or content portions, or additional visual effects that are associated with relevant content or content portions. Other examples, may include types of interface controls such as an overlay or any type of temporary visual layer that sits above the user interface (UI) partially or fully over the underlying content to capture input.

In some examples, the message server receives edit operation data from an interface control positioned on an image 405, content, or display portion of a first user device or recipient of the message. The displayed interior portion or segment can be highlighted, marked, or otherwise selected by the user of the content shown on a display of the first user device. The interface control is positioned on an interior portion enabling the user device to embed a graphical icon directly within that portion or segment or shown to be attached or associated in some manner to the portion of interest of the image 405 to inform the originator or a second user device of a response to the message and in particular the portion of interest of interest.

In some examples, the messaging application 35 (of FIG. 1) may employ intelligent algorithms, such as implementing an artificial intelligence model that makes contextual determinations of the image or uses available metadata about the image and other attributes and suggests potentially relevant graphical icons for user selection upon selection of regions of the image. For example, an image such as of an individual may be shown with clothes or accessories that may be user-selectable within the image, and emoticons may be automatically associated with selected items within the image.

### Example Operations

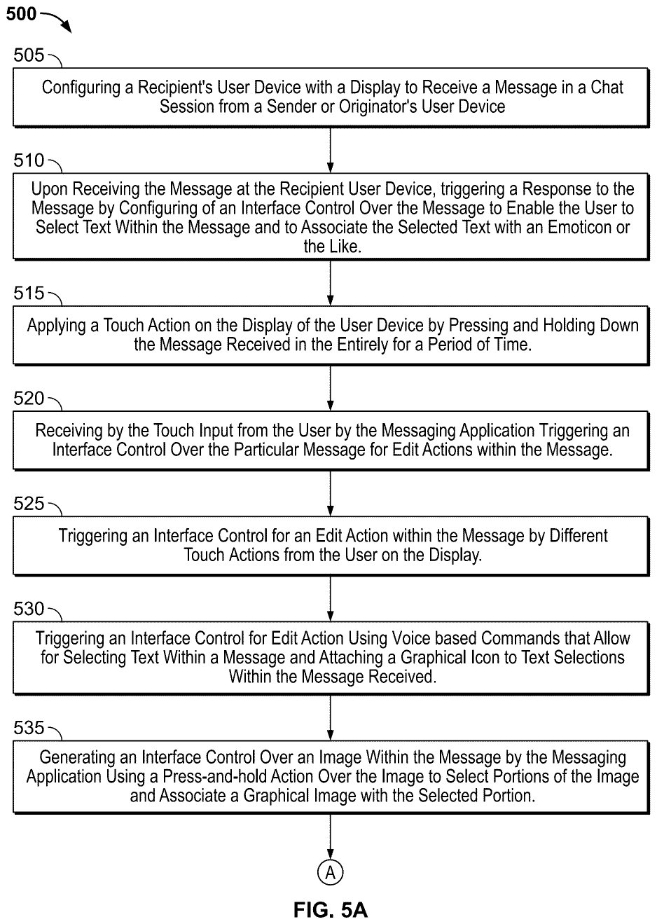

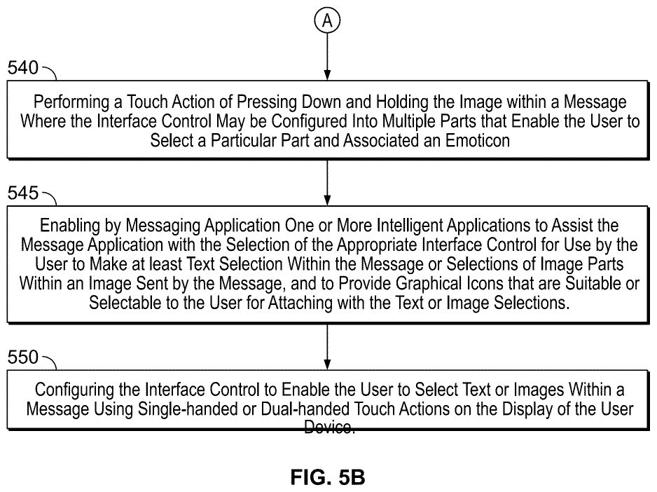

FIGS. 5A and 5B illustrate sequence diagrams of operations that can be used to emote response messages in which text portions have been selected and associated with emoticons or other graphical icons by at least the user, according to some examples. In FIGS. 5A and 5B there is shown a sequence of a flow diagram 500 of operations that enable a recipient on a recipient user device to receive and edit a message by selecting portions of text within the message and associating a graphical icon to the selected portion as a response to a sent text in a chat session. For example, using a multiple manual touch process of selecting a message in its entirety, then automatically after a period of time being able via an interface control triggered to edit within the message; subsequent selecting text within the message, and automatically after the selection being assisted by the messaging application with one or more graphical icons to select, and selecting a graphical icon by a touch action. Finally, have the selected text within the message and the graphical icon associated with it automatically sent by the messaging application as a quick response to the originator of the message, giving the originator notification of having reviewed the message and of a particular aspect within the message that the recipient has identified.

At step 505, a recipient user device 102 with a display receives a message in a chat session from a sender user device 104 that is communicating with the recipient user device 102 using a messaging application 35. The chat session may be composed of a single message or multiple messages that are being sent.

At step 510, upon receiving the message at the recipient user device 102 (or by viewing a previous message that is sent to the recipient user device in a thread of messages), the messaging application 35 on the recipient user device 102 is triggered or by the user to provide a response to the message that includes initiating an interface control over the message to enable the user to select text within the message and to associate the selected text with an emoticon or the like.

At step 515, the user, using a touch action on the display of the recipient user device 102, presses and holds down the message received in its entirety for a period of time. The pressing and holding down action by the user actuates, signals, indicates, or triggers the messaging application 35 to actuate an interface control to enable an edit action by the user of the message.

At step 520, the messaging application 35, by receiving the touch input from the user, may cause an interface control over the particular message to be triggered immediately (or after a delay) for editing within the message or may configure different interface controls based on the time of the message being touched and held. For example, more than one type of interface control may be configured in a multiple-step or two-step operation based on the touch action of the user over the particular message. As an example, a first type of interface control may be configured based on the first action of the user pressing and holding down the message for a first period of time to enable attaching a graphical icon to the exterior of the message and another type of interface control configured in a second action based on the user pressing and holding down the message for a longer period of time that enables the user to edit within the message region (in other words within the interior of the message). In some examples, the user may be provided a notification by different formatting or transforming of the message to show the user that the message is editable in its interior after the second period of time. Hence, by integrating multiple different periods of time of pressing and holding down on the message, different types of editing of the message, whether it is directed to the message exterior or interior and attaching of an emoticon or the like, may be actuated.

At step 525, in an alternate example, the editing operation may be configured by different touch actions (single and double tap operations) on a region of the message that was received in the chat session to allow for generating a first type of interface control over the message for attaching of the graphical icon based on the single tap action by the user on the message; and to allow for a second type of interface control over the message for enabling edit actions such as text selections within the message based on a double tap action by the user on the message. It is contemplated that a variety of different user touch actions can allow for configuring edit actions within or exterior of a message.

At step 530, in another example, edit operations may be configured using voice based commands that allow for selecting text within a test message and attaching a graphical icon to text selections within the message received. For example, a user may use a microphone attached to the recipient user device 102 to speak voice commands to trigger an interface control over the message to allow for text selection within the message and automatically generate graphical icons, such as emoticons, for selection and associating with the text response. In this example, the messaging application 35 may be configured to receive input by voice and apply NLP and other intelligent algorithms to configure an appropriate interface control and to make text selections with the message on the display of the recipient user device 102. For example, the messaging application 35 may generate a set of graphical icons for selection and for associating with the text selection, or may automatically associate a particular graphical icon with the selected text.

At step 535, the messaging application 35 may be configured to generate an interface control over an image sent to the recipient device. Similar to text selection, a recipient using a press-and-hold action over the image is able to select portions of the image and associate a graphical image with the selected portion. For example, the user of the recipient user device 102 may press down and hold the image sent in the message to trigger, indicate, or signal the messaging application 35 to generate an interface control over the image. Subsequently, the user of the recipient user device 102, in the chat session, would select a portion of the image by manual selection and then select an emoticon or other graphical icon that would be automatically presented to the user of the recipient the user device 102 by the messaging application 35 for selection and associate with the selected portion of the image. In some examples, the messaging application 35 or message server may receive an indication of a selection of a graphical icon by an edit action or edit operation of a selection of a type of emoticon by the user of the recipient user device 102 (i.e., first user device). Once selected by the user, the edit actions to the image would be presented on the sender user device 104 (e.g., second user device) as a response to the image sent in the message.

At step 540, in the case of an image sent to the recipient user device 102, the image upon user performing a touch action of pressing down and holding the image, the interface control may be configured into multiple parts that enable the user to select a particular part and have an emoticon or other graphical icon generate or a set of emoticons or graphical icons generated for user selection and to provide an immediate inline response to the sender user device 104 of a particular feature or part shown in the image sent in the message by the association of the graphical icon. For example, to attach an emoticon to selected text, the messaging application 35 (of FIG. 1) may use the window.getSelection( ) and Range APIs, which allows the application to use the interface control to determine the exact portion of text the user has highlighted. Once the user has made the selection, the application extracts the selected text and creates a new element (such as a <span>) and inserts the selected text along with your chosen emoticon (for example, “smiley face emoticon”) into that element. Then, remove the original highlighted text from the DOM and insert the new element in its place. This way, the selected text is replaced with a visually annotated version that includes both the original text and the emoticon. Also, the user using the application and the interface control can enhance this by styling the span (e.g., highlighting it) or by providing multiple emoticons for the user to choose from. In instances that the application requires more advanced editing and annotation features (like handling overlapping selections, storing annotations for later editing, or integrating with a text editor library). In that case, this approach can be modified accordingly to include other editing features and linked libraries.

At step 545, the messaging application 35 may be configured with a set of intelligent applications that are in operable communication with the message server to assist the messaging application 35 with the selection of the appropriate overly for the use by the user to make at least text selection within the message or selections of image parts within an image sent by the message and to provide graphical icons that are suitable or selectable to the user or user device for attaching with the text or image selections.

At step 550, the interface control is configured to enable a text selection of image selection within a message to be performed by single-handed or dual-handed touch actions by the user on the display of the user device. For example, the interface control is triggered based on touch and holding operation by the user using one-handed operations and being able to touch the particular message displayed on the user's device and by pressing and holding down the message using a single-handed operation. In some examples, the single handed operation may be able to configure multiple types of interface controls that are responsive based on the user's touch operations or the length of time that the user presses down and holds the selected message on display. For example, the user pressing down and holding the message may be configured by using a single-hand operation with also voice commands. The portion of the text selection or image selection may also be configured with a single-hand operation or by voice commands, thereby enabling dual modal editing action features to make an emoticon-based response to text or parts of a message. The response to the message of the text or image portion selection combined with a graphical icon selected, such as an emoticon, may also be performed with the single hand operation or automatically upon the text or image portion selection by the user using intelligent algorithms and setting configured with the messaging application 35.

### Example Architecture

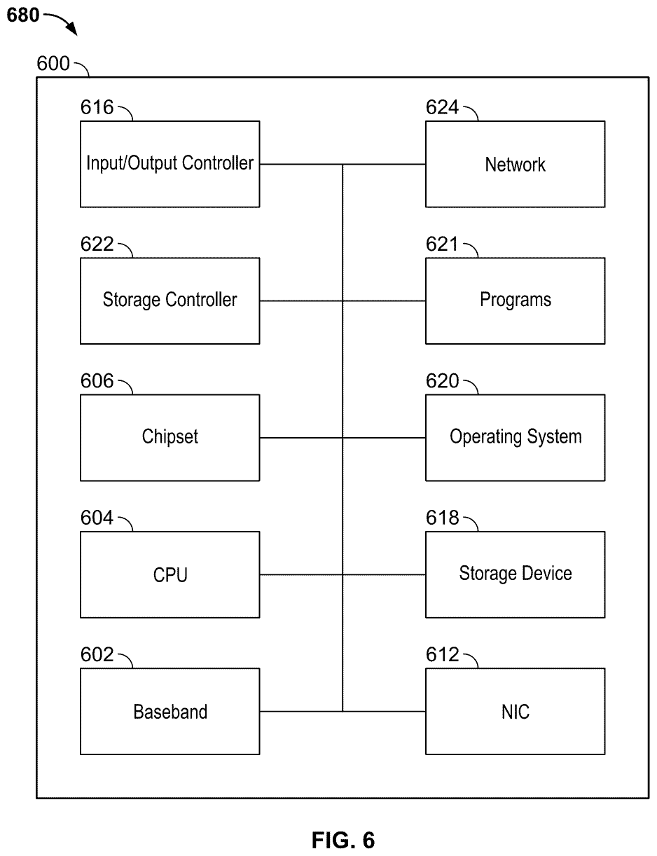

FIG. 6 illustrates a computer system 680 suitable for implementing one or more embodiments disclosed herein. FIG. 6 illustrates a schematic view of an example computer hardware architecture for implementing a user device, etc., that can be utilized to implement aspects of the various technologies presented herein. The computer architecture shown in FIG. 6 illustrates a conventional server computer, network device, workstation, desktop computer, laptop, tablet, network appliance, e-reader, smartphone, and/or another computing device. It can be utilized to execute any of the software components presented herein. The computer 600 may comprise networked devices such as servers, switches, routers, hubs, bridges, gateways, modems, repeaters, access points, etc.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPU 604 and the remainder of the components and devices on the baseboard 602. The chipset 606 can provide an interface to RAM, used as the main memory in the computer 600. The chipset 606 can further provide an interface to a computer-readable storage medium such as read-only memory (“ROM”) or non-volatile RAM (“NVRAM”) for storing basic routines that help to start up the computer 600 and to transfer information between the various components and devices. The ROM or NVRAM can also store other software components necessary for the operation of the computer 600 in accordance with the configurations described herein.

The computer 600 can operate in a networked environment using logical connections to remote computing devices and computer systems through a network, such as network(s) 624. The chipset 606 can include functionality for providing network connectivity through a NIC 612, such as a gigabit Ethernet adapter. The NIC 612 is capable of connecting the computer 600 to other computing devices over the network. It should be appreciated that multiple NICs 612 can be present in the computer 600, connecting the computer to different types of networks and remote computer systems. In some examples, the NIC 612 may be configured to perform at least some of the techniques described herein and may include components for performing the techniques described herein.

The computer 600 can be connected to a storage device 618 that provides non-volatile storage for the computer. The storage device 618 can store an operating system 620, programs, and data, which have been described in greater detail herein. The storage device 618 can be connected to the computer 600 through a storage controller 622 connected to the chipset 606. The storage device 618 can consist of one or more physical storage units. The storage controller 622 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of the physical state can depend on various factors in different embodiments of this description. Examples of such factors can include but are not limited to, the technology used to implement the physical storage units, whether the storage device 618 is characterized as primary or secondary storage, and the like.

For example, computer 600 can store information to the storage device 618 by issuing instructions through the storage controller 622 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data, and that can be accessed by the computer 600. In some examples, the operations performed by the network and or any components included therein may be supported by one or more devices similar to Computer 600. As stated otherwise, some or all of the operations performed by the network and or any components included therein may be performed by one or more computers devices (computer 600) operating in a cloud-based arrangement.

By way of example, and not limitation, computer-readable storage media can include volatile and non-volatile, removable and non-removable media implemented in any method or technology. Computer-readable storage media includes but is not limited to RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT® Corporation of Redmond, Washington. According to further embodiments, the operating system can comprise the UNIX operating system or one of its variants. It should be appreciated that other operating systems can also be utilized. The storage device 618 can store other system or application programs 621 (e.g., intelligent algorithms, Artificial Intelligence (AI Applications, Machine learning Models, LLM models, etc.) and data utilized by the computer 600.

In one example, the storage device 618 or other computer-readable storage media is encoded with computer-executable instructions which, when loaded into the computer 600, transform the computer from a general-purpose computing system into a special-purpose computer capable of implementing the techniques described herein. These computer-executable instructions transform the computer 600 by specifying how the CPU 604 transitions between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of the controller and other devices used in the telemetry data collection and the like. The computer 600 may include one or more hardware processors (CPUs 604) configured to execute one or more stored instructions. The processor(s) may comprise one or more cores. Further, the Computer 600 may include one or more network interfaces (e.g., NIC 612) configured to provide communications between the Computer 600 and other devices over a network 624. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth. The network interfaces may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices.

The network connectivity device (e.g., NIC 612) may provide wired communication links and/or wireless communication links. Wired communication links may be provided in accordance with Ethernet (IEEE 802.6), Internet protocol (IP), time division multiplex (TDM), data over cable service interface specification (DOCSIS), wavelength division multiplexing (WDM), and/or the like. In an embodiment, a radio transceiver cards may provide wireless communication links using protocols such as code division multiple access (CDMA), global system for mobile communications (GSM), long-term evolution (LTE), Wi-Fi (IEEE 802.11), Bluetooth, Zigbee, narrowband Internet of things (NB IoT), near field communications (NFC), and radio frequency identity (RFID).

The radio transceiver cards may promote radio communications using 5G, 5G New Radio, or 5G LTE radio communication protocols. These network connectivity devices (computer 600) may enable the CPU 604 to communicate with the Internet or one or more intranets. With such a network connection, it is contemplated that the CPU 604 (e.g., processor) might receive information from the network or might output information to the network in the course of performing the above-described method steps. Such information, which is often represented as a sequence of instructions to be executed using a processor, may be received from and outputted to the network, for example, in the form of a computer data signal embodied in a carrier wave.

Programs 621 instructing the CPU 604 may comprise any program or process to perform the techniques described in this disclosure for using computer networking protocol extensions (e.g., SNI, ECH, etc.) as a mechanism for collecting telemetry data from a management plane via a controller and for generating rule sets for processing by the telemetry engine.

It is well known in both the electrical engineering and software engineering fields that any functionality realizable by loading software instructions into a computer may also be implemented in hardware using standard design techniques. The choice between implementing a design in software or hardware usually hinges on factors such as the design's stability and the expected production volume rather than the feasibility of converting from software to hardware. In practice, designs subject to frequent revisions are often implemented in software first because modifying hardware is more costly than updating software. Conversely, a stable design intended for large-scale production may be more economically realized in hardware, such as an application-specific integrated circuit (ASIC), since hardware can be less expensive at higher production volumes. Often, a design is initially created and tested in software form and then, using well-known design principles, converted into an equivalent hardware implementation in an ASIC that “hardwires” the software instructions. In the same way that a machine governed by a new ASIC is considered a particular machine, a computer that is programmed and/or loaded with executable instructions likewise qualifies as a specific machine or apparatus.

Such information, which may include data or instructions to be executed using CPU 604, for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

In an embodiment, the computer system 680 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by two or more computers.

In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third-party provider.

### Conclusion

In some aspects, the techniques described herein relate to a method including: sending, by a message server to a first user device, a first message that is sent by a second user device for display at the first user device, wherein the first message as displayed by a display of the first user device includes an interface control that is configured to receive at least one edit action to a portion of a content within the first message; receiving, by the message server, data of the at least one edit action at the first user device to the portion of the content within the first message, wherein the at least one edit action is performed while the content within the first message is displayed on the display of the first user device and includes at least one of a content selection to the portion of the content within the first message or associating one or more graphical icons to the portion of the content within the first message at the first user device; generating, by the message server, a second message including at least one of a representation of the content selection to the portion of the content within the first message or a representation of an association of the one or more graphical icons to the portion of the content within the first message; and sending, by the message server, the second message to the second user device for display at the second user device, wherein the display of the second message provides a notification of a response from the first user device to the portion of the content within the first message.

In some aspects, the techniques described herein relate to a method, wherein associating the one or more graphical icons to the portion of the content within the first message includes inserting a graphical icon in the portion of the content such that the graphical icon is associated with a highlight to the portion of the content in the second message that is sent to the second user device.

In some aspects, the techniques described herein relate to a method, wherein receiving, by the message server, the data of the at least one edit action includes: receiving an indication of a selection of the graphical icon in a form of an emoticon using the interface control configured over the portion of the content, wherein the portion of the content within the first message is emoted by the emoticon; and wherein generating, by the message server, the second message includes generating, a notification of emoting of the portion of the content within the first message to the second user device.

In some aspects, the techniques described herein relate to a method, wherein receiving, by the message server, the data of the at least one edit action includes receiving one or more highlights of content in the portion of content within the first message to associate with the one or more graphical icons.

In some aspects, the techniques described herein relate to a method, wherein generating, by the message server, the second message includes generating the second message that to include the one or more highlights of the content in the portion of the content within the first message that are associated with the one or more graphical icons.

In some aspects, the techniques described herein relate to a method, wherein receiving, by the message server, the data of the at least one edit action includes receiving a selection of a portion of an image within the first message, and wherein generating, by the message server, the second message includes generating the second message to comprise a representation of the selection of the portion of the image within the first message and the association of the graphical icon to the portion of the image within the first message.

In some aspects, the techniques described herein relate to a method, wherein receiving, by the message server, the data of the at least one edit action includes receiving from the interface control over the portion of content, selected content that is that is within an interior portion of the content that is displayed on the display of the first user device to enable attachment of the graphical icon to the interior portion of the content.

In some aspects, the techniques described herein relate to a method, wherein receiving, by the message server, the data of the at least one edit action includes receiving from the interface control over the portion of content of a selected image that is within an interior portion of the image that is displayed on the display associated with the first user device to enable attachment of the graphical icon to the interior portion of the image.

In some aspects, the techniques described herein relate to a method, wherein the message server is a Rich Communication Services (RCS) server.

In some aspects, the techniques described herein relate to a message server, including: one or more processors; and memory storing computer-executable instructions that, when executed by the one or more processors, cause the message server to: send to a first user device, a first message that is sent by a second user device for display at the first user device, wherein the first message as displayed by a display of the first user device includes an interface control that is configured to receive at least one edit action to a portion of a content within the first message; receive data of the at least one edit action at the first user device to the portion of the content within the first message, wherein the at least one edit action is performed while the content within the first message is displayed on the display of the first user device and includes at least one of a content selection to the portion of the content within the first message or associating one or more graphical icons to the portion of the content within the first message at the first user device; generate a second message including at least one of a representation of the content selection to the portion of the content within the first message or a representation of an association of the one or more graphical icons to the portion of the content within the first message; and send the second message to the second user device for display at the second user device, wherein the display of the second message provides a notification of a response from the first user device to the portion of the content within the first message.

In some aspects, the techniques described herein relate to a message server, wherein the association of the one or more graphical icons to the perform of the content with the first message comprises insertion of a graphical icon within the content of the first message received from the second user device to be associated with highlighted content to the portion of the content within the first message when returned to the second user device.

In some aspects, the techniques described herein relate to a message server, wherein receive the data of the at least one edit action comprises receive an indication of a selection of a graphical icon in a form of an emoticon using an interface control configured for the portion of the content within the first message that is emoted by the emoticon; and wherein generate the second message comprise generation a notification of the portion of the content within the first message that is emoted by the emoticon to the second user device.

In some aspects, the techniques described herein relate to a message server, wherein receive the data of the at least one edit action includes receive one or more highlights of content in the portion of content within the first message to associate with the one or more graphical icons.

In some aspects, the techniques described herein relate to a message server, wherein generate the second message comprises generate the second message to include the one or more highlights of the content in the portion of the content within the first message that is associated with the one or more graphical icons.

In some aspects, the techniques described herein relate to a message server, wherein receive the data of the at least one edit action that includes receive a selection of a portion of an image within the first message, and wherein generate the second message comprises generate the second message to include a representation of the selection of the portion of the image within the first message and the association of the graphical icon to the portion of the image within the first message.

In some aspects, the techniques described herein relate to a message server, wherein receive the data of the at least one edit action comprises receive from the interface control over the portion of content, selected content that is within an interior portion of the content that is displayed on the display of the first user device to enable attachment of the graphical icon to the interior portion of the content.

In some aspects, the techniques described herein relate to a message server, receive the data of the at least one edit action includes receive from the interface control over the portion of content, a selected image that is within an interior portion of the image that is displayed on the display associated with the first user device to enable attachment of the graphical icon to the interior portion of the image.

In some aspects, the techniques described herein relate to one or more non-transitory computer-readable media storing computer-executable instructions that, when executed by one or more processors of a first user device, cause first user device to perform operations including: receiving, by a first user device from a message server, a first message that has been sent by a second user device; displaying, the first message on a display of the first user device, wherein the first message as displayed by a display of the first user device comprises an interface control that is configured to receive at least one edit action to a portion of a content within the first message, wherein the at least one edit action is performed while the content within the first message is displayed on the display of the first user device and comprises at least one of a content selection to the portion of the content within the first message or associating one or more graphical icons to the portion of the content within the first message; and sending, by the first user device, data of the at least one edit action at the first user device to the portion of the content within the first message to the message server, wherein the data of the at least one edit action initiates the message server to generate a second message comprising at least one of a representation of the content selection to the portion of the content within the first message or a representation of an association of the one or more graphical icons to the portion of the content within the first message for sending to the second user device.

In some aspects, the techniques described herein relate to one or more non-transitory computer-readable media, wherein the second message is displayed by the second user device on a display of the second user device to provide a notification of a response from the first user device to the portion of the content within the first message.

In some aspects, the techniques described herein relate to one or more non-transitory computer-readable media, wherein the associating the one or more graphical icons to the portion of the content within the first message comprises inserting a graphical icon in the portion of the content such that the graphical icon is associated with a highlight to the portion of the content in the second message that is sent to the second user device.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method comprising:
sending, by a message server to a first user device, a first message that is sent by a second user device for display at the first user device, wherein the first message as displayed by a display of the first user device comprises an interface control that is configured to receive at least one edit action to a portion of a content within the first message;
receiving, by the message server, data of the at least one edit action at the first user device to the portion of the content within the first message, wherein the at least one edit action is performed while the content within the first message is displayed on the display of the first user device and comprises at least one of a content selection to the portion of the content within the first message or associating one or more graphical icons to the portion of the content within the first message at the first user device;
generating, by the message server, a second message comprising at least one of a representation of the content selection to the portion of the content within the first message or the representation of an association of the one or more graphical icons to the portion of the content within the first message; and
sending, by the message server, the second message to the second user device for display at the second user device, wherein the display of the second message provides a notification of a response from the first user device to the portion of the content within the first message.

2. The method of claim 1, wherein associating the one or more graphical icons to the portion of the content within the first message comprises inserting a graphical icon in the portion of the content such that the graphical icon is associated with a highlight to the portion of the content in the second message that is sent to the second user device.

3. The method of claim 2, wherein receiving, by the message server, the data of the at least one edit action comprises receiving an indication of a selection of the graphical icon in a form of an emoticon using the interface control configured over the portion of the content, wherein the portion of the content within the first message is emoted by the emoticon;
and wherein generating, by the message server, the second message comprises generating, a notification of emoting of the portion of the content within the first message to the second user device.

4. The method of claim 2, wherein receiving, by the message server, the data of the at least one edit action comprises receiving one or more highlights of content in the portion of content within the first message to associate with the one or more graphical icons.

5. The method of claim 4, wherein generating, by the message server, the second message comprises generating the second message to comprise the one or more highlights of the content in the portion of the content within the first message that are associated with the one or more graphical icons.

6. The method of claim 5, wherein receiving, by the message server, the data of the at least one edit action comprises receiving a selection of a portion of an image within the first message, and wherein generating, by the message server, the second message comprises generating the second message to comprise a representation of the selection of the portion of the image within the first message and the association of the graphical icon to the portion of the image within the first message.

7. The method of claim 6, wherein receiving, by the message server, the data of the at least one edit action comprises receiving from the interface control over the portion of content, selected content that is that is within an interior portion of the content that is displayed on the display of the first user device to enable attachment of the graphical icon to the interior portion of the content.

8. The method of claim 6, wherein receiving, by the message server, the data of the at least one edit action comprises receiving, from the interface control over the portion of content, a selected image that is within an interior portion of the image that is displayed on the display associated with the first user device to enable attachment of the graphical icon to the interior portion of the image.

9. The method of claim 1, wherein the message server is a Rich Communication Services (RCS) server.

10. A message server, comprising:
one or more processors; and
memory storing computer-executable instructions that, when executed by the one or more processors, cause the message server to:
send to a first user device, a first message that is sent by a second user device for display at the first user device, wherein the first message as displayed by a display of the first user device comprises an interface control that is configured to receive at least one edit action to a portion of a content within the first message;
receive data of the at least one edit action at the first user device to the portion of the content within the first message, wherein the at least one edit action is performed while the content within the first message is displayed on the display of the first user device and comprises at least one of a content selection to the portion of the content within the first message or associating one or more graphical icons to the portion of the content within the first message at the first user device;
generate a second message comprising at least one of a representation of the content selection to the portion of the content within the first message or the representation of an association of the one or more graphical icons to the portion of the content within the first message; and
send the second message to the second user device for display at the second user device, wherein the display of the second message provides a notification of a response from the first user device to the portion of the content within the first message.

11. The message server of claim 10, wherein the association of the one or more graphical icons to the portion of the content within the first message comprises insertion of a graphical icon within the content such that the graphical icon is associated with a highlight to the portion of the content in the second message that is sent to the second user device.

12. The message server of claim 11, wherein receive the data of the at least one edit action comprises receive an indication of a selection of a graphical icon in a form of an emoticon using the interface control configured for the portion of the content within the first message that is emoted by the emoticon; and wherein generate the second message comprises generate a notification of the portion of content within the first message that is emoted by the emoticon to the second user device.

13. The message server of claim 12, wherein receive the data of the at least one edit action comprises receive one or more highlights of content in the portion of content within the first message to associate with the one or more graphical icons.

14. The message server of claim 13, wherein generate the second message comprises generate the second message to comprise the one or more highlights of the content in the portion of the content within the first message that is associated with the one or more graphical icons.

15. The message server of claim 14, wherein receive the data of the at least one edit action comprises receive a selection of a portion of an image within the first message, and wherein generate the second message comprises generate the second message to comprise a representation of the selection of the portion of the image within the first message and the association of the graphical icon to the portion of the image within the first message.

16. The message server of claim 15, wherein receive the data of the at least one edit action comprises receive from the interface control over the portion of content, selected content that is within an interior portion of the content that is displayed on the display of the first user device to enable attachment of the graphical icon to the interior portion of the content.

17. The message server of claim 16, wherein the receive the data of the at least one edit action comprises receive from the interface control over the portion of content, a selected image that is within an interior portion of the image that is displayed on the display associated with the first user device to enable attachment of the graphical icon to the interior portion of the image.

18. One or more non-transitory computer-readable media storing computer-executable instructions that, when executed by one or more processors of a first user device, cause the first user device to perform operations comprising:
receiving, by a first user device from a message server, a first message that has been sent by a second user device;
displaying the first message on a display of the first user device, wherein the first message as displayed by a display of the first user device comprises an interface control that is configured to receive at least one edit action to a portion of a content within the first message, wherein the at least one edit action is performed while the content within the first message is displayed on the display of the first user device and comprises at least one of a content selection to the portion of the content within the first message or associating one or more graphical icons to the portion of the content within the first message; and
sending, by the first user device, data of the at least one edit action at the first user device to the portion of the content within the first message to the message server, wherein the data of the at least one edit action initiates the message server to generate a second message comprising at least one of a representation of the content selection to the portion of the content within the first message or a representation of an association of the one or more graphical icons to the portion of the content within the first message for sending to the second user device.

19. The one or more non-transitory computer-readable media of claim 18, wherein the second message is displayed by the second user device on a display of the second user device to provide a notification of a response from the first user device to the portion of the content within the first message.

20. The one or more non-transitory computer-readable media of claim 19, wherein the associating the one or more graphical icons to the portion of the content within the first message comprises inserting a graphical icon in the portion of the content such that the graphical icon is associated with a highlight to the portion of the content in the second message that is sent to the second user device.
